(19) United States
(12) Patent Application Publication
(10) Pub. No.: US 2013/0049315 A1
(43) Pub. Date: Feb. 28, 2013

(54) MULTI-USE CART FOR OUTDOOR ACTIVITIES AND INNER CITY USE

(71) Applicants: Ronald Lee Lowe, Interlochen, MI (US); Daniel A. Cadoret, Williamsburg, MI (US)

(72) Inventors: Ronald Lee Lowe, Interlochen, MI (US); Daniel A. Cadoret, Williamsburg, MI (US)

(21) Appl. No.: 13/594,745

(22) Filed: Aug. 24, 2012

Related U.S. Application Data
(60) Provisional application No. 61/527,396, filed on Aug. 25, 2011.

(51) Int. Cl. B62B 1/04

(52) U.S. Cl. 280/47.315

(57) ABSTRACT

A multi-use cart is configured and designed to transport a specific style of foldable camp chair and other necessary items such as rain jackets, lap blankets and other items used in outdoor activities. The cart can convert for inner city use for daily activities such as shopping or transportation of goods. This can eliminate carrying goods by hand which can allow people to move about with ease and comfort, making the whole experience more enjoyable.

### CROSS-REFERENCE TO RELATED APPLICATION

This application claims the benefit of priority of U.S. provisional application No. 61/527,396, filed Aug. 25, 2011, the contents of which are herein incorporated by reference.

### BACKGROUND OF THE INVENTION

The present invention relates to multi-use carts and, more particularly, to a multi-use cart for outdoor activities and inner city use.

Carrying chairs and other necessary items used in outdoor activities/events can be burdensome. Moreover, in inner city living, people often carry groceries, laundry and other items by hand to and from their homes. These tasks can be awkward and, at times, painful in regards to body discomfort such as arm, shoulder, back and neck pain. Carrying multiple items can potentially lead to falling and injuring oneself.

Various wheeled carts have been developed to transport chairs, however, such carts are not designed for specific types or styles of chairs and such carts are not designed for inner city living. There are also carts used to carry groceries, laundry, or the like, but these carts are not designed for use to easily and conveniently carry chairs.

As can be seen, there is a need for a multi-use cart designed for outdoor activities as well as inner city use.

### SUMMARY OF THE INVENTION

In one aspect of the present invention, a multi-use cart comprises a base member; an extension rod extending upwards from the base member; wheels rotatably disposed on opposite sides of the base member; and first and second chair straps adapted to loop around folded chairs supported on the base member.

In another aspect of the present invention, a multi-use cart comprises a base member; an extension rod extending upwards from the base member; wheels rotatably disposed on opposite sides of the base member; first and second chair straps adapted to loop around folded chairs supported on the base member; at least one cup holder attached to the extension rod; a pocket attached to the extension rod; and a bag operable to be disposed on the base and attached to the extension rod.

These and other features, aspects and advantages of the present invention will become better understood with reference to the following drawings, description and claims.

### BRIEF DESCRIPTION OF THE DRAWINGS

FIG. 1 is a perspective view of a multi-use cart, configured with a bag, according to an exemplary embodiment of the present invention;

FIG. 2 is a front perspective view of the multi-use cart of FIG. 1, configured without the bag for chair carrying, according to an exemplary embodiment of the present invention;

FIG. 3 is a back view of the multi-use cart of FIG. 2;

FIG. 4 is a side view of the multi-use cart of FIG. 2;

FIG. 5 is a rear perspective view of the multi-use cart of FIG. 2;

FIG. 6 is a detailed perspective view of a cart support bracket of the multi-use cart of the present invention;

FIG. 7 is a perspective view of a handle of the multi-use cart of the present invention, showing a handle pivot function; and

FIG. 8 is a perspective view of a multi-use cart having simultaneous chair-carrying and bag use functions, according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a multi-use cart configured and designed to transport a specific style of foldable camp chair and other necessary items such as rain jackets, lap blankets and other items used in outdoor activities. The cart can convert for inner city use for daily activities such as shopping or transportation of goods. This can eliminate carrying goods by hand which can allow people to move about with ease and comfort, making the whole experience more enjoyable.

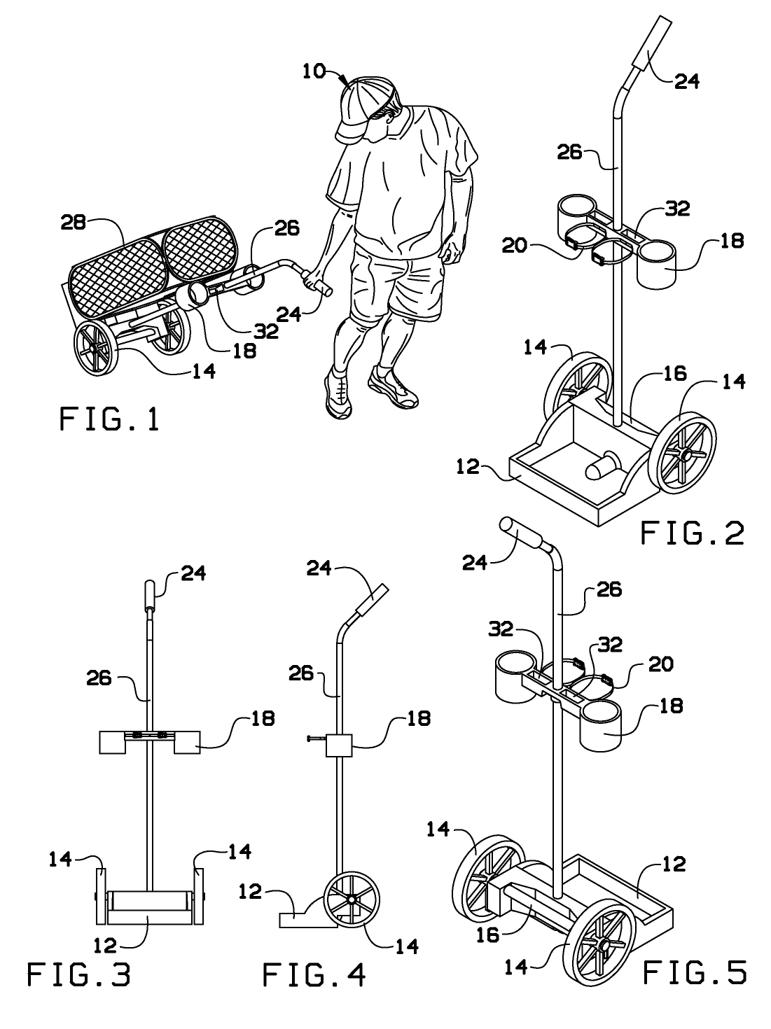

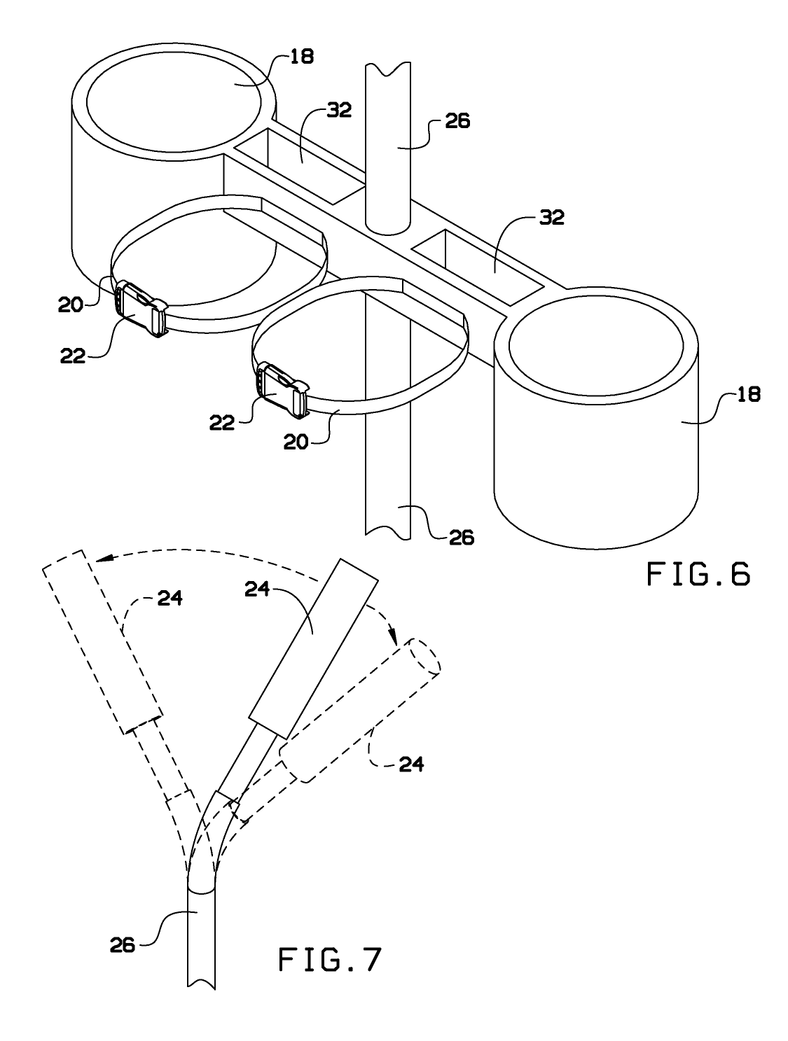

Referring now to FIGS. 1 through 6, a multi-use cart can include a base 12 having an axel 16 passing through and attached along one side of the base 12. Wheels 14 can be attached to each end of the axel 16. An extension rod 26 can extend upward from the base 12. When the extension rod 26 is angled to cause the wheels 14 to support the base 12, the base 12 can be easily moved about on the wheels 14.

A handle grip 24 can be disposed on an end of the extension rod 26. The handle grip 24 can be disposed at an angle relative to the extension rod 26. In some embodiments, the handle grip 24 can pivot about the extension rod 26, as shown in FIG. 7.

From about one-half to about three-quarters up the extension rod 26 from the base 12, a support member can be disposed. The support member can include chair straps 20 adapted to loop about folded chairs supported from the base 12. Typically, two chair straps 20 are disposed to permit carrying two folded chairs side-by-side. A chair strap buckle 22 can be used to connect or disconnect the loops formed by the chair straps 20. The chair strap buckle 22 can include a mechanism to adjust the length of the chair strap 20, allowing the chair strap 20 to fit snugly about a chair.

Other accessories can be disposed on the support member. For example, cup holders 18 can be attached to the extension rod 26. Pockets 32 can be formed in the support member to hold various items, such as a mobile phone or the like.

In some embodiments, the extension rod 26 may have a height adjustment feature, allowing the length of the extension rod 26 to adjust for people of different heights.

As shown in FIG. 1, a bag 28 can be supported by the base 12 and can be used to carry items, such as shopping bags, gardening supplies, beach supplies, sporting goods or other items, such as those often carried in inner city areas or for outdoor activities. The bag 28 can simply rest on the base 12 in some embodiments. In other embodiments, a connection feature can be provided, such as a snap, to connect the bag 28 to the base 12.

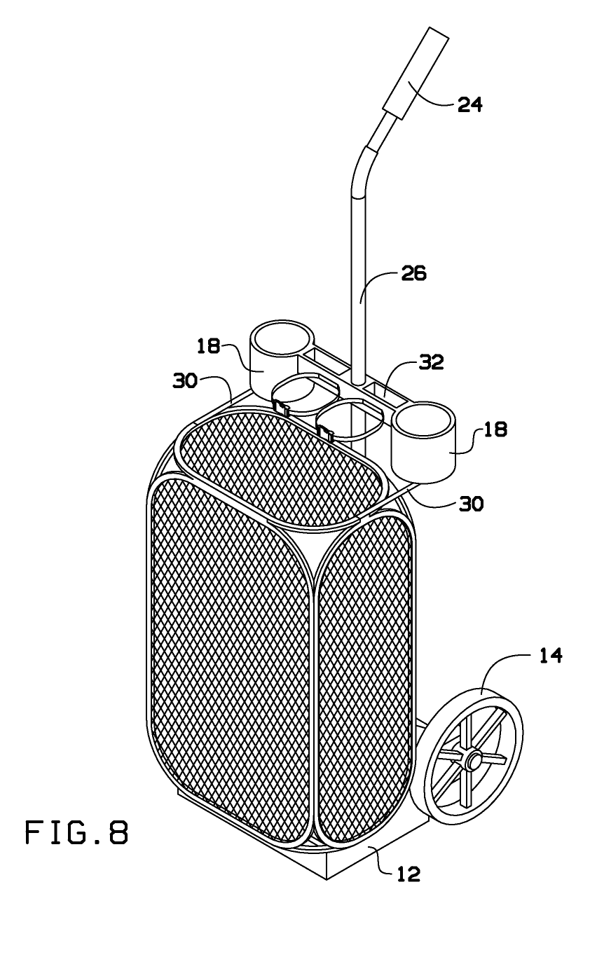

In some embodiments, the bag 28 can be attached to the extension rod 26 with the chair straps 20. In other embodiments, as shown in FIG. 8, a bag strap 30 can be used to support the bag 28 while still allowing the chair straps 20 to be used to hold one or more folded chairs. In this embodiment, the base 12 may be made deeper to fully support the bag 28 while also supporting chairs connected with the chair straps 20.

The multi-use cart of the present invention can be made in various sizes, depending on the application. For example, the base can be from about 9 to about 14 inches wide by about 6 to 14 inches long. The base could include a base back portion that can rise from about 1 to about 4 inches from the base to help support the chairs supported on the base. The wheels can be from about 6 to about 12 inches in diameter and from about 1 to about 6 inches wide, for example. The size of the wheels can vary with application and, in some embodiments, the wheels may be changed by the user 10. For example, a beach use application may work best with wide, large wheels, while a street application may work best with more narrow wheels.

The multi-use cart of the present invention can be manufactured from various materials. The multi-use cart can be made from more than one material, as may be needed. For example, various components of the multi-use cart can be made of plastic, composite, wood, metal and the like. The bag can be made of various materials, such as canvas, nylon, cotton, plastic, metal, wood or the like.

Variations apart from those shown in the figures are contemplated within the scope of the present invention. For example, the chair straps could be disposed behind the extension rod to provide additional storage in front of the extension rod. Other features, such as an umbrella, table, hard bag, batteries for charging mobile devices, a solar cell, or the like, can be added to the multi-use cart of the present invention.

The multi-use cart can be used for multiple purposes. Some of these purposes include, but are not limited to, shopping, gardening, sport equipment, fishing gear, laundry, portable electronics charging station, and the like. Advertising can be placed on sides of the cart or the bag to providing a unique advertising opportunity.

It should be understood, of course, that the foregoing relates to exemplary embodiments of the invention and that modifications may be made without departing from the spirit and scope of the invention as set forth in the following claims.

What is claimed is:

1. A multi-use cart comprising:
a base member;
an extension rod extending upwards from the base member;
wheels rotatably disposed on opposite sides of the base member; and
first and second chair straps adapted to loop around folded chairs supported on the base member.

2. The multi-use cart of claim 1, further comprising at least one cup holder attached to the extension rod.

3. The multi-use cart of claim 1, further comprising a pocket attached to the extension rod.

4. The multi-use cart of claim 1, further comprising a handle grip disposed on an end of the extension rod.

5. The multi-use cart of claim 4, wherein the handle grip pivots about the end of the extension rod.

6. The multi-use cart of claim 1, further comprising a bag operable to be disposed on the base and attached to the extension rod.

7. The multi-use cart of claim 1, further comprising chair strap buckles operable to form the first and second chair straps in a loop and adjust the size of the loop.

8. The multi-use cart of claim 6, wherein the bag is attached to the extension rod with the first and second chair straps.

9. The multi-use cart of claim 6, further comprising a bag strap operable to connect the bag to the extension rod while permitting first and second chairs to be retained by the first and second chair straps.

10. A multi-use cart comprising:
a base member;
an extension rod extending upwards from the base member;
wheels rotatably disposed on opposite sides of the base member;
first and second chair straps adapted to loop around folded chairs supported on the base member;
at least one cup holder attached to the extension rod;
a pocket attached to the extension rod; and
a bag operable to be disposed on the base and attached to the extension rod.

11. The multi-use cart of claim 10, further comprising a handle grip disposed on an end of the extension rod.

12. The multi-use cart of claim 10, wherein the bag is attached to the extension rod with the first and second chair straps.

13. The multi-use cart of claim 10, further comprising a bag strap operable to connect the bag to the extension rod while permitting first and second chairs to be retained by the first and second chair straps.
